(19) United States
(12) Patent Application Publication
(10) Pub. No.: US 2014/0018494 A1
(43) Pub. Date: Jan. 16, 2014

(54) Optically Clear Composition

(71) Applicant: Mustafa A. Mohamed, Quincy, MA (US)

(72) Inventor: Mustafa A. Mohamed, Quincy, MA (US)

(73) Assignee: DOW CORNING CORPORATION, Midland, MI (US)

(21) Appl. No.: 14/007,659

(22) PCT Filed: Mar. 19, 2012
(86) PCT No.: PCT/US2012/029605

§ 371 Date: Sep. 26, 2013

Related U.S. Application Data
(60) Provisional application No. 61/470,130, filed on Mar. 31, 2011.

(51) Int. Cl. C08G 77/00; C09D 183/08

(52) U.S. Cl. CPC C08G 77/70; C09D 183/08
USPC 524/588; 528/33

(57) ABSTRACT

An optically clear composition includes a condensation curable silicone-organic copolymer. This copolymer has at least one alkoxysilane group, at least one T unit, and at least one Q unit. A silicon atom of at least one of the T and Q units is bonded to a urea group and/or a urethane group. This copolymer is condensation cured to form a film. In addition, a coating system includes a clear coat layer that includes the condensation cured copolymer and at least one sub-clear coat layer disposed in contact with the clear coat layer.

The present invention generally relates to an optically clear composition. More specifically, the composition includes a condensation curable silicone-organic copolymer having at least one alkoxysilane group, at least one T unit, and at least one Q unit, wherein a silicon atom of at least one of the T and Q units is bonded to a urea group and/or a urethane group.

The general use of optically clear (e.g. transparent) compositions and films formed from the cured compositions is known in the art. Typically, optically clear silicon containing compositions include partial condensates of silanols and are used to form films on substrates or articles to provide mechanical protection and abrasion/scratch resistance. However, these films tend to be brittle and are prone to chipping and thermal cracking. More specifically, these films tend to be rigid (i.e., non-flexible) such that they cannot easily expand and contract with heating and cooling. For this reason, these films tend to crack into pieces under changing thermal conditions. Accordingly, there remains an opportunity to develop an improved composition and corresponding film.

The instant invention provides an optically clear composition. The composition includes a condensation curable silicone-organic copolymer having at least one alkoxysilane group, at least one T unit, and at least one Q unit. A silicon atom of at least one of the T and Q units is bonded to a urea group and/or a urethane group. This invention also provides a film including the condensation cured silicone-organic copolymer. This invention further provides a coating system including a clear coat layer including the condensation cured silicone-organic copolymer and at least one sub-clear coat layer disposed in contact with the clear coat layer. The urea and/or urethane groups increase the flexibility of the film/clear coat layer, decrease the vulnerability of the film/clear coat layer to chipping and thermal cracking, and simultaneously allow the film/clear coat layer to maintain abrasion and scratch resistance.

The present invention provides an optically clear composition (hereinafter referred to as the “composition”) along with a film and a coating system including a clear coat layer, described in greater detail below. Typically, the film and the clear coat layer are also optically clear and tend to allow light to pass through such that each may be described as transparent, translucent, or see-through. Typically, the composition, film, and/or clear coat layer reflect little light, e.g., less than 30, 25, 20, 15, 10, 5, 4, 3, 2, or 1, %, so that the light passes directly through which contributes to optical clarity. In various embodiments, the composition, film, and/or clear coat layer has a light transmittance of at least 50, 60, 70, 80, 90, 95, or 99 percent, as determined using a spectrophotometer, e.g., with ASTM D1003. In other embodiments, the composition, film, and/or clear coat layer has a light transmittance approaching 100 percent. Each of the composition, film, and clear coat layer is typically free of pigment and is not coloured or tinted by use of pigments. In various embodiments, each includes less than 10, 5, 4, 3, 2 or 1, weight percent of pigment. However, it is contemplated that the composition, film, and/or clear coat layer may be coloured and remain transparent or see-through.

### The Composition

The composition includes a condensation curable silicone-organic copolymer (hereinafter referred to as the “copolymer”). The composition may include the copolymer alone or the copolymer combined with one or more additives, solvents, etc. In one embodiment, the composition consists essentially of the copolymer and is free of other polymers and copolymers. In another embodiment, the composition includes the copolymer and one or more organic polymers and/or one or more silanes, siloxanes, silazanes, silylenes, silyl groups or ions, elemental silicon, silenes, silanols, polymers thereof, and combinations thereof. The composition may alternatively consist of the copolymer.

As is well known in the art, hydrolysis and condensation reactions are related and are their equilibrated reaction schemes are typically described as follows:

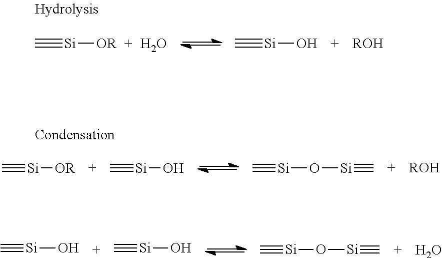

wherein R is typically an alkyl group. Accordingly, in the instant invention, the copolymer typically cures (or cross-links) upon initiation of a condensation reaction, as shown above. In other words, the copolymer typically cures when Si—O—Si bonds are formed between independent molecules of the copolymer via condensation reactions resulting in generation of alcohols (such as ROH, e.g. methanol and ethanol) and water.

The copolymer includes at least one alkoxysilane group (Si—OR) so that the copolymer can be condensation curable and can cure via formation of Si—O—Si bonds. Most typically, the copolymer includes two or multiple alkoxysilane groups. If the alkoxysilane group(s) are terminal, the copolymer typically is chain extended. If the alkoxysilane group(s) are pendant, the copolymer typically becomes branched or cross-linked. The alkoxysilane group(s) may be present as terminal and pendant groups simultaneously. The alkoxysilane group(s) are not particularly limited and may be any known in the art wherein R is an alkyl group that includes one or more carbon atoms. However, typical alkoxysilane groups are methoxy, ethoxy, and propoxy groups, i.e., groups that include 3 or less carbon atoms. In various embodiments, all of the alkoxysilane groups in the copolymer are methoxy, ethoxy, and/or propoxy groups. Most typically, all of the alkoxysilane groups in the copolymer are methoxy groups. The alkoxysilane group is not a silanol (Si—OH) group.

Preferably, each alkoxysilane group has 3 or less carbon atoms, and is most preferably a methoxy group, so that the copolymer can cure effectively and can form a cohesive film, as described in greater detail below. Without intending to be bound by any particular theory, it is believed that large alkoxysilane groups can cause individual copolymer molecules to space apart and not as effectively pack together during cure. In addition, large alkoxysilane groups may sterically shield other smaller alkoxysilane groups from effectively participating in condensation reactions. Most typically, the silicon atom of the alkoxysilane group is a portion of at least one M, D, T, or Q unit of the copolymer. However, it is contemplated that the silicon atoms of the alkoxysilane group may be independent from these units.

The copolymer includes at least one T unit, and at least one Q unit. Typically, the copolymer includes a plurality of, or multiple, T units and/or Q units. However, the copolymer may include only a single T unit and a single Q unit. In various embodiments, the copolymer includes a ratio of T to Q units of from 1:1 to 10:1, 2:1 to 9:1, 3:1 to 8:1, 4:1 to 7:1, or 5:1 to 6:1. It is also contemplated that the copolymer may include a ratio of T to Q units of about 10:1, of about 9:1, of about 8:1, of about 4:1, etc.

The copolymer may also include one or more D units. In various embodiments, the copolymer includes from 1 to 30, from 1 to 20, or from 1 to 10, parts by weight of D units per 100 parts by weight of the copolymer. In other embodiments, the copolymer includes from 1 to 30, from 1 to 20, or from 1 to 5, parts by weight of M units per 100 parts by weight of the copolymer. Alternatively, the copolymer may be free of M units.

The symbols M, D, T, and Q used above represent the functionality of structural units of polyorganosiloxanes. The symbols are used in accordance with established understanding in the art. Thus, M represents the monofunctional unit R₃SiO_{1/2}. D represents the difunctional unit R₂SiO_{2/2}. T represents the trifunctional unit RSiO_{3/2}. Q represents the tetrafunctional unit SiO_{4/2}. Generic structural formulas of these units are shown below:

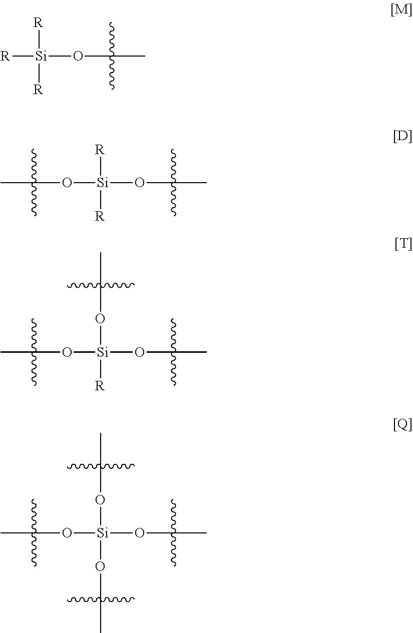

In these immediately aforementioned formulae, each R is typically independently an alkyl group of C₁-C₁₂, preferably C₁-C₅, and most preferably is a methyl or ethyl group. However, the invention is not limited to these groups, or to alkyl groups in general.

In the copolymer, a silicon atom of at least one of the T and/or Q units is bonded to a urea group and/or a urethane group, most typically through a carbon chain. It is also contemplated that a silicon atom of at least one D unit may be bonded to a urea group and/or a urethane group, for example, through a carbon chain. A nitrogen atom of the urea and/or urethane group is not typically bonded directly to a silicon atom. Instead, the nitrogen atom is typically directly bonded to a carbon atom that itself is bonded directly to a silicon atom or is part of a chain of carbon atoms wherein one of those carbon atoms is bonded to a silicon atom or is bonded to an oxygen atom that, in turn, is directly bonded to a silicon atom of at least T unit or Q unit. The chain of carbon atoms that typically connects the urea and/or urethane groups to the silicon atom typically has from 1 to 10, from 1 to 5, or from 1 to 3, carbon atoms. In one embodiment, the chain of carbon atoms includes 2 or 3 carbon atoms. Most typically, one or more of the urea and/or urethane groups are terminal or end-capping groups of the copolymer such that they modify the copolymer. It is contemplated that the copolymer may include one or more urea and/or urethane groups that are terminal or end-capping and also simultaneously include one or more urea and/or urethane groups that are pendant, i.e., not terminal or end-capping.

The silicon atoms of one or more D units may be bonded to one or more urea groups, one or more urethane groups, or one or more urea groups and one or more urethane groups simultaneously, in the same or a different way as described above. Similarly, the silicon atoms of one or more T units may be bonded to one or more urea groups, one or more urethane groups, or one or more urea groups and one or more urethane groups simultaneously, in the same or a different way as described above. In addition, the silicon atoms of one or more Q units may be bonded to one or more urea groups, one or more urethane groups, or one or more urea groups and one or more urethane groups simultaneously, in the same or a different way as described above. The silicon atoms of one or more D units, T units, and Q units may be bonded to the same or different urea and/or urethane groups, as described above. In addition, silicon atoms of one or more optional M units may be bonded to the urea and/or urethane groups, in the same or a different way as described above. As is known in the art, urea and urethane groups have the following generalized structures:

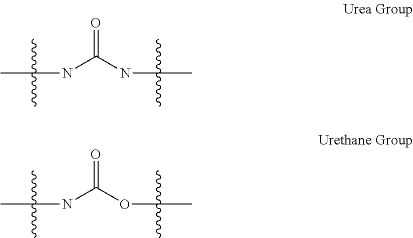 [SMILES: *NC(=O)N* ; *NC(=O)O*]

In various embodiments, the copolymer includes two urea groups or two urethane groups bonded to one or more silicon atoms of the D, T and/or Q units. It is contemplated that the urea and/or urethane groups can be prepared using the reaction of isocyanates with amine or alcohol functional silanes or silicones. However, the invention is not limited to such a preparation method.

It is to be understood that the urea and/or urethane groups may be bonded to one or more silicon atoms simultaneously. Each of those silicon atoms may be a part of/belong to different M/D/T/Q units. However, it is typical to describe a urea and/or urethane group as bonded to a silicon atom of a D unit if that silicon atom is directly bonded to two oxygen atoms. In addition, it is typical to describe a urea and/or urethane group as bonded to a silicon atom of a T unit if that silicon atom is directly bonded to three oxygen atoms. Similarly, it is typical to describe a urea and/or urethane group as bonded to a silicon atom of a Q unit if that silicon atom is directly bonded to four oxygen atoms. The urea and/or urethane groups may be bonded directly to one or more silicon atoms, i.e., through a covalent bond connecting the silicon atom directly with an atom of the urea and/or urethane group. However, it is also contemplated that the urea and/or urethane group(s) may be indirectly bonded to the silicon atom, as described above, such as through a carbon chain. For example, one or more urea and/or urethane groups may be bonded to another atom or group which, in turn, is directly bonded to the silicon atom. In this example, the other atom or group may be directly covalently bonded to the silicon atom of the D, T and/or Q units.

The copolymer is not particularly limited in structure so long as it has at least one alkoxysilane group, at least one T unit, and at least one Q unit. The copolymer is typically a random copolymer but may be further defined as an AB or ABA copolymer. The copolymer may be linear, branched, or cyclic. The copolymer may include a greater weight percent of organic groups (e.g. the urea and/or urethane groups) than silicone (e.g. polyorganosiloxane) groups or vice versa. Typically, the copolymer includes a weight percentage of organic groups of from 20 to 40, of from 10 to 30, or from 1 to 10, percent based on a total weight of the copolymer. Similarly, the copolymer typically includes a weight percent of silicone groups of from 40 to 60, of from 60 to 80, or from 90 to 99, percent based on a total weight of the copolymer. The copolymer may alternatively include an approximately equal weight percentage of organic groups and silicone groups. The terminology “organic groups” typically includes the urea/urethane groups but may also include alkyl groups, alkenyl groups, alkynyl groups, aromatic groups, aldehydes, ketones, esters, ethers, and the like. The terminology “silicone groups” typically includes polyorganosiloxane groups such as M/T/D/Q units.

The copolymer is also not particularly limited in length, molecular weight, polydispersity, viscosity, or degree of cross-linking (e.g. cross-link density). In various embodiments, the copolymer has a weight average molecular weight of from 900 to 200,000, of from 900 to 50,000, or of from 900 to 30,000, g/mol. In other embodiments, the copolymer has a number average molecular weight of from 500 to 30,000, of from 500 to 20,000, or of from 500 to 10,000, g/mol. The copolymer typically has a polydispersity of from 1.3 to 6, of from 1.3 to 5, or of from 1.3 to 4.

Various Non-Limiting Reactions that May be Used to Form the Copolymer

The copolymer is also not particularly limited relative to a method of forming, synthesis, or preparation. The copolymer may be formed by any method known in the art and may be formed through use of various prepolymers, non-limiting examples of which are described below. Most typically, the copolymer is formed through reaction of a prepolymer with a T/Q resin. In various embodiments, the prepolymer includes urea and/or urethane functionality and reactive terminal T-units. It is contemplated that the copolymer of this invention may include, or be formed from/using, one or more of the following reaction products, branching and cyclic derivatives thereof, multi-isocyanate/amine/alkoxy derivatives thereof, hydrolysis and condensation reaction products and derivatives thereof, and combinations thereof.

### Non-Limiting Prepolymer Examples (Prepolymers I-III)

1. Monoisocyanate+Alkoxysilane Terminated Amine→(I) Alkoxysilane-Urea Prepolymer

### For Example

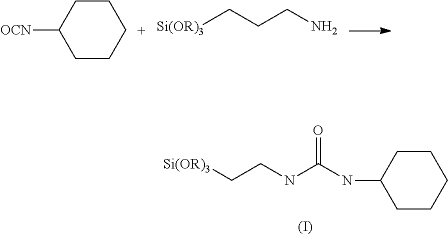 [0022] In this embodiment, the Prepolymer (I) has a terminal T-unit.
2. Diisocyanate+Alkoxysilane Term. Amine→(II) Alkoxysilane-Urea Prepolymer

### For Example

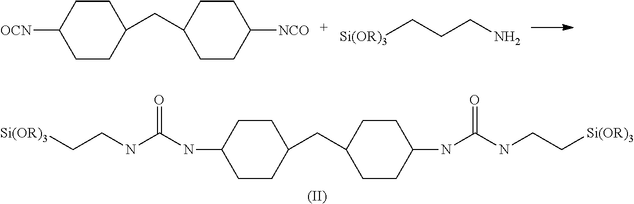

In this embodiment, the Prepolymer (II) has two terminal T-units.
3. Diisocyanate+Alkoxysilane Term. Amine→(III) Alkoxysilane-Urea-NCO Prepolymer

### For Example

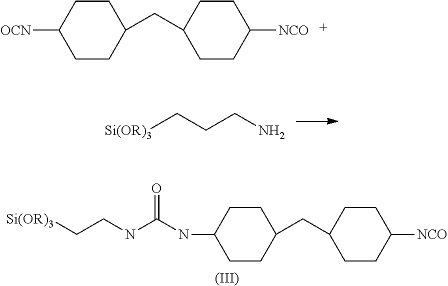

In this embodiment, the Prepolymer (III) has a terminal T-unit.

### Non-Limiting Inventive Copolymer Examples

4. Prepolymer III+Diamine Terminated T/Q Polyorganosiloxane→Inventive Copolymer

### For Example

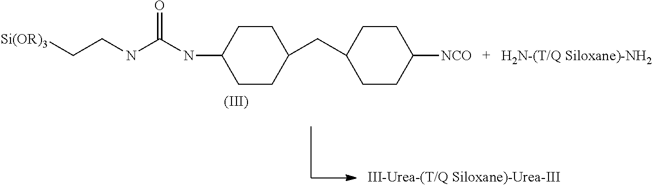 [0031] 5. Prepolymer III+Monoamine Term. T/Q Polyorganosiloxane→Inventive Copolymer

### For Example

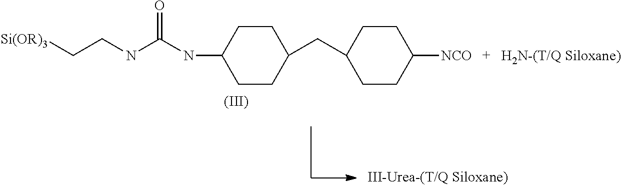 [0033] 6. Prepolymer III+Dialcohol Term. T/Q Polyorganosiloxane→Inventive Copolymer

### For Example

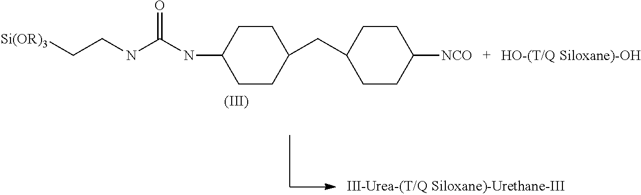 [0035] 7. Prepolymer III+Monoalcohol Term. T/Q Polyorganosiloxane→Inventive Copolymer

### For Example

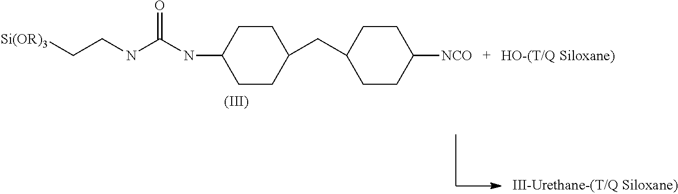 [0037] 8. Prepolymer III+Monoamine/Monoalcohol Term. T/Q Polyorganosiloxane→Inventive Copolymer

### For Example

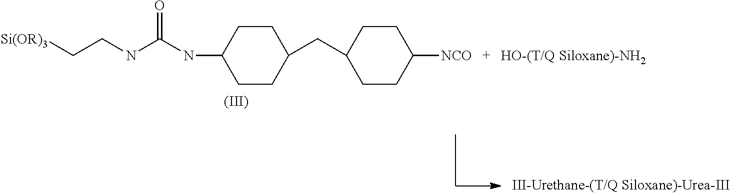

### Additional Non-Limiting Prepolymer Examples (Prepolymers IV-VI)

9. Monoisocyanate+Alkoxysilane Terminated Alcohol→(IV) Alkoxysilane-Urethane Prepolymer

### For Example

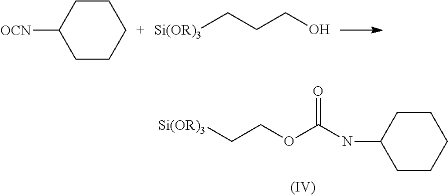

In this embodiment, the Prepolymer (IV) has a terminal T-unit.
10. Diisocyanate+Alkoxysilane Term. Alcohol→(V) Alkoxysilane-Urethane-Urethane-Alkoxysilane Prepolymer

### For Example

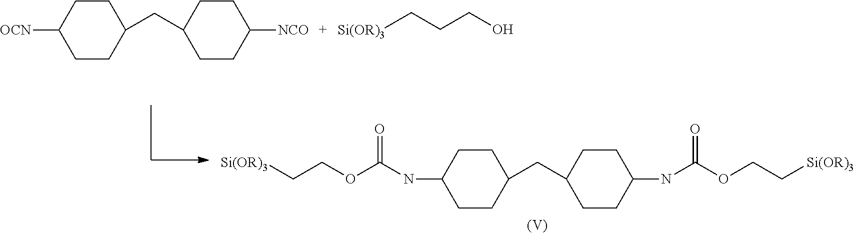

In this embodiment, the Prepolymer (V) has two terminal T-units.
11. Diisocyanate+Alkoxysilane Term. Alcohol→(VI) Alkoxysilane-Urethane-NCO Prepolymer

### For Example

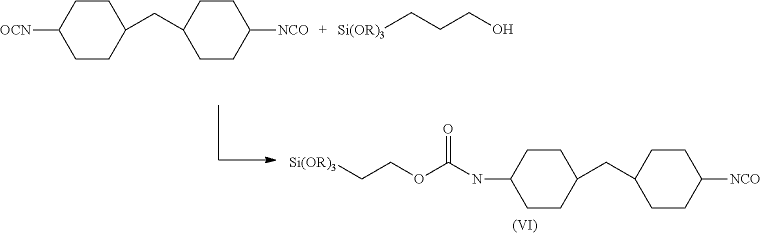

In this embodiment, the Prepolymer (VI) has a terminal T-unit.

### Non-Limiting Inventive Copolymer Examples:

12. Prepolymer VI+Diamine Terminated T/Q Polyorganosiloxane→Inventive Copolymer

### For Example

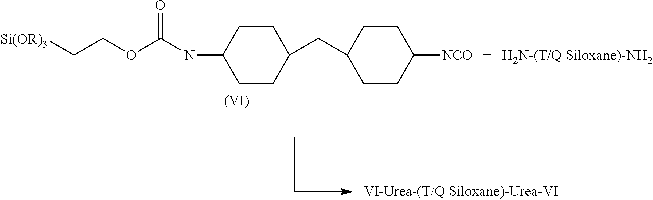 [0050] 13. Prepolymer VI+Monoamine Term. T/Q Polyorganosiloxane→Inventive Copolymer

### For Example

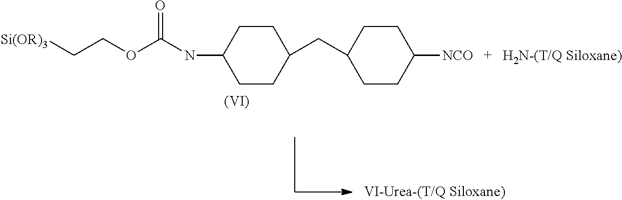 [0052] 14. Prepolymer VI+Dialcohol Term. T/Q Polyorganosiloxane→Inventive Copolymer

### For Example

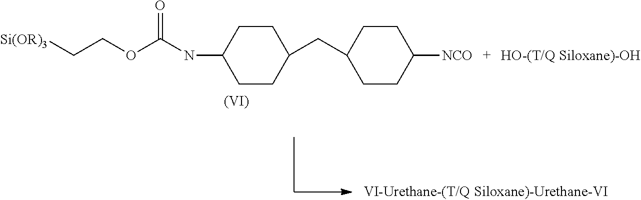 [0054] 15. Prepolymer VI+Monoalcohol Term. T/Q Polyorganosiloxane→Inventive Copolymer

### For Example

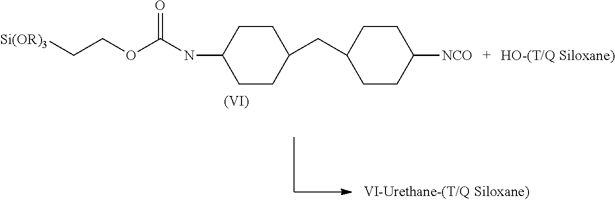 [0056] 16. Prepolymer VI+Monoamine/Monoalcohol Term. T/Q Polyorganosiloxane→Inventive Copolymer

### For Example

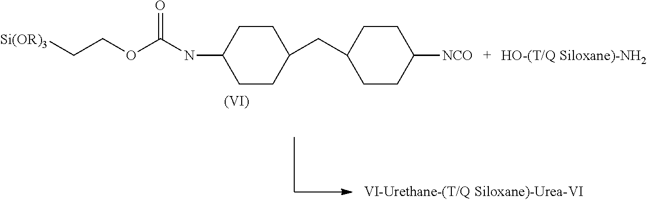

### Additional Non-Limiting Copolymer Examples:

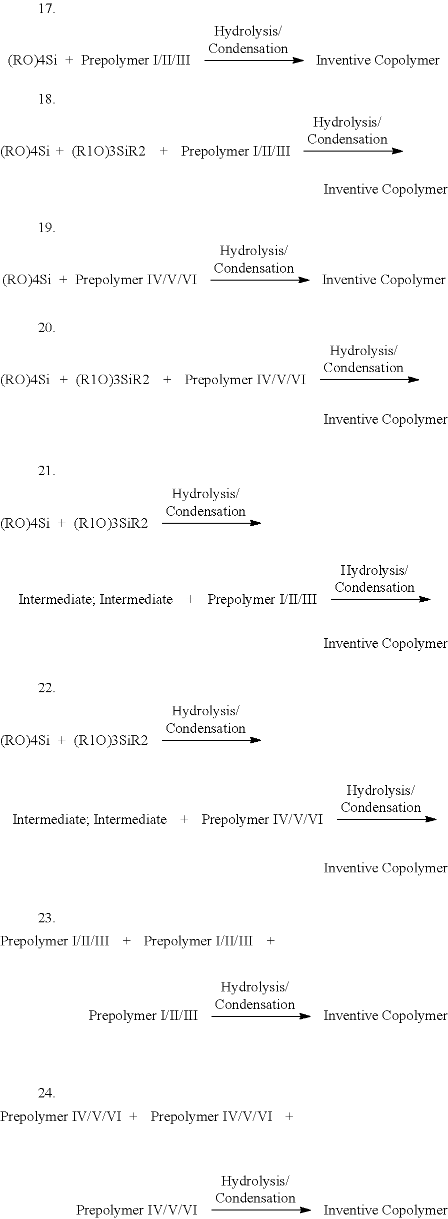

wherein, typically, each of R, R¹ and R² is independently an alkyl group having 3 or less carbon atoms. However, R, R¹ and R² are not limited in this way and may be any alkyl group. In the aforementioned non-limiting reaction examples, the terminology “urea” represents a urea bond/group, the terminology “urethane” represents a urethane bond/group, and the terminology “NCO” represents a free isocyanate group. This invention also contemplates products similar to those described above but that are different in structure based on molar amounts of the prepolymers and/or T/Q siloxanes described above. As just one non-limiting example, a di-functional prepolymer may react at one or both functional sites depending on how many moles of the T/Q siloxane are present such that a single product or mixture of products may result.

In additional embodiments, the copolymer is formed from, or includes the reaction product of, various alkoxysilanes that include urea and/or urethane groups with themselves or the reaction product of alkoxysilanes that do not include urea and/or urethane groups with one or more compounds that include urea and/or urethane groups. For example, prepolymers (i.e., alkoxysilanes) I-VI above may react with one or more of themselves, may react with other alkoxysilanes that include urea and/or urethane groups, may react with other alkoxysilanes that do not include urea and/or urethane groups, and/or may react with precursors to Q and T units, such as (RO)₄Si and (R¹O)₃SiR². It is also contemplated that precursors to M and D units may also react with one or more alkoxysilanes described above.

In reactions 1-3 and 9-11 above, isocyanates (i.e., compounds that include one or more “NCO” bonds) react with amine (NH, NH₂, or NH₃) groups or alcohol (—OH) groups to form alkoxysilane-ureas and -urethanes, respectively. Typically, these alkoxysilane-ureas and -urethanes are prepolymers that may be further reacted to form the copolymer of this invention (i.e., the inventive copolymer described above). The prepolymers may have one or more urea or urethane terminal groups and/or one or more free isocyanate (NCO) groups for further reaction.

Relative to reactions 4-8 and 12-16 above, one or more of the prepolymers I-VI react with various amine and alcohol terminated polyorganosiloxanes, e.g. T/Q polyorganosiloxanes, by hydrolysis and/or condensation to form the copolymer. Relative to reactions 23 and 24, one or more of the prepolymers I-VI react with one or more of themselves, via hydrolysis and/or condensation, to form the copolymer.

Relative to reactions 17-20, precursors to Q and T units, such as (RO)₄Si and (R¹O)₃SiR², react with one or more of the prepolymers I-VI to form the copolymer. Alternatively, as set forth in reactions 21 and 22, these precursors may react with themselves via hydrolysis and/or condensation to form an intermediate which is then reacted with one or more of the prepolymers I-VI to form the copolymer.

In a further non-limiting example, the following reactions and reactants are utilized. In addition, branching and cyclic derivatives thereof, multi-isocyanate/amine/alkoxy derivatives thereof, hydrolysis and condensation reaction products and derivatives thereof, and combinations thereof, may also be utilized

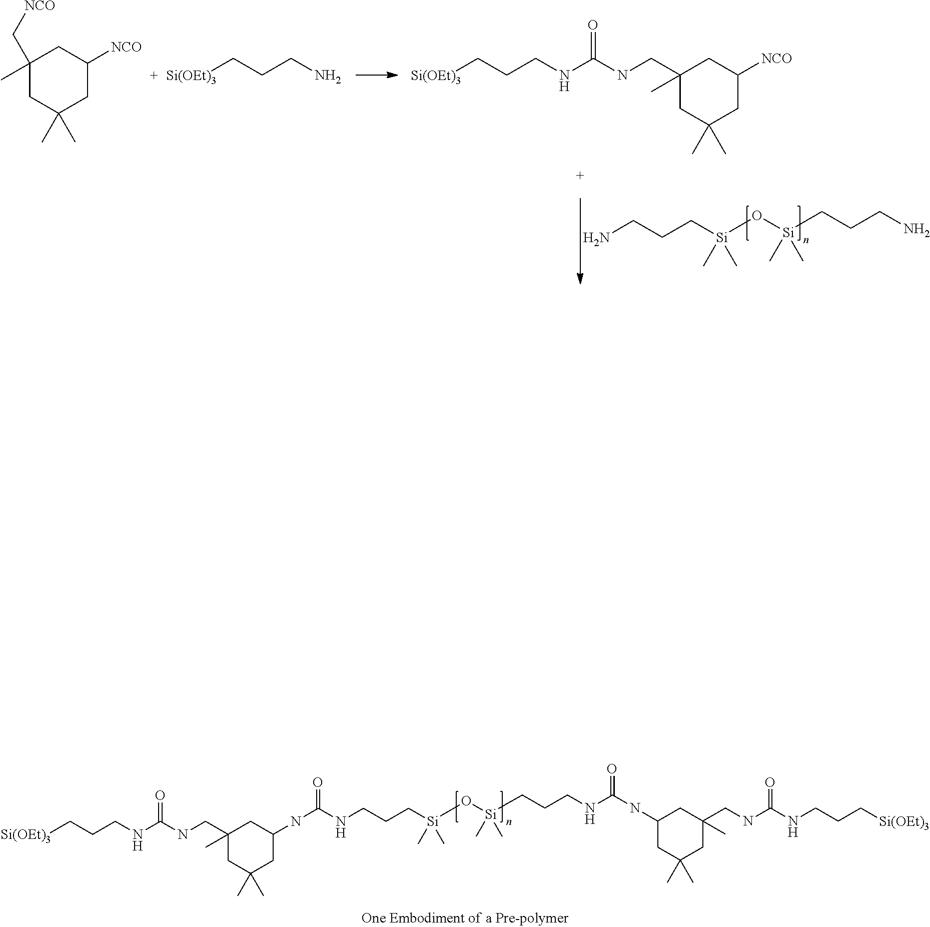

wherein n is from 1 to 30. In this embodiment, one or more derivatives (n=1 to 30) of this prepolymer are added to a T/Q resin to form the inventive copolymer.

It is also contemplated that the copolymer may be formed in-situ by reacting, for example, colloidal silica formed from co-hydrolysis of a tetraalkoxysilane, such as tetraethoxysilane (TEOS), and methyl trimethoxysilane (MTM), with a catalyst and water to form a reaction product (i.e., a TQ resin) that is then further reacted with a prepolymer or other silicone resin to form the copolymer of this invention. Alternatively, MTM may be blended with colloidal silica having a particle size of about 10-15 nm in a methanol solution (e.g. MS-30, commercially available from Nissan Chemicals) to form a reaction product (i.e., a TQ resin) that is then further reacted with a prepolymer or other silicone resin to form the copolymer of this invention. The colloidal silica may alternatively be blended with partially hydrolyzed MTM. Several colloidal silica products with different colloidal particle sizes can be utilized.

In another embodiment (e.g. in reaction scheme 18 above), the copolymer is formed by reacting a Q resin precursor ((RO)₄Si) with an alkoxyfunctional silicone-urea/urethane prepolymer (e.g. as formed in reaction scheme 2 above). A T resin precursor ((R¹O)₃SiR²) can also be reacted. These reactions are typically completed in the presence of acid and H₂O followed by removal of ROH, e.g. by the Dean-Starck distillation. For example the reaction can be as follows:

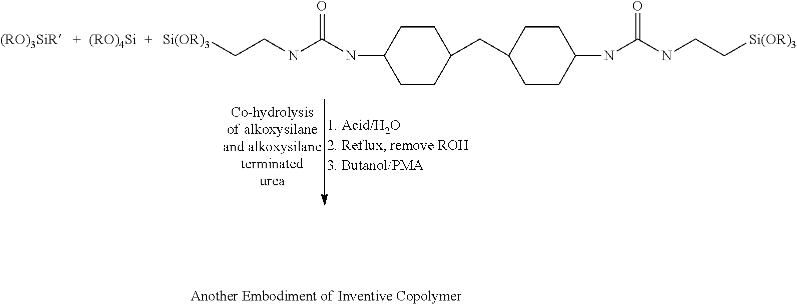

As also described above (e.g. in reaction schemes 21 and 22), the Q and T precursors may be reacted to form an intermediate, e.g. a partially condensed alkoxysilane, in presence of water and after removal of alcohol under reflux. Subsequently, the intermediate may react with an Alkoxysilane-Urea-Urea-Alkoxysilane (e.g. compound (II) above). The reaction can be as follows

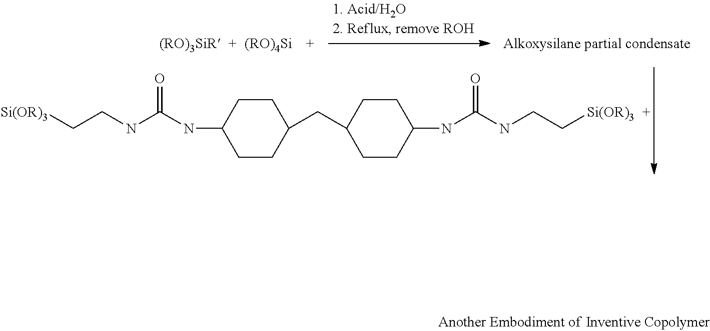

More generally, in one embodiment, the copolymer includes the reaction product of (a) a urea having a terminal alkoxysilane group and a terminal isocyanate group and (b) an amine terminated polyorganosiloxane. In another embodiment, the copolymer includes the reaction product of (a) the urea having a terminal alkoxysilane group and a terminal isocyanate group and (c) an alcohol terminated polyorganosiloxane. In still another embodiment, the copolymer includes the reaction product of (d) a urethane having a terminal alkoxysilane group and a terminal isocyanate group and (b) the amine terminated polyorganosiloxane. In a further embodiment, the copolymer includes the reaction product of (d) the urethane having a terminal alkoxysilane group and a terminal isocyanate group and (c) the alcohol terminated polyorganosiloxane. The (a) urea may be further defined as having two urea groups. The (b) polysiloxane may be further defined as having two terminal amine groups. The (c) polysiloxane may be further defined as having two terminal alcohol groups. The (d) urethane may be further defined as having two urethane groups.

It is also contemplated that the copolymer may include the co-hydrolysis reaction product of (e) a urea having two terminal alkoxysilane groups and (f) (RO)₄Si, wherein R is an alkyl group having 3 or less carbon atoms. In addition, in a related embodiment, the co-hydrolysis reaction product may be further defined as the product of (e), (f), and (g) (R¹O)₃SiR², wherein each of R¹ and R² is independently an alkyl group having 3 or less carbon atoms. Alternatively, the copolymer may include the condensation reaction product of [a hydrolysis reaction product of (RO)₄Si and (R¹O)₃SiR², wherein each of R, R¹ and R² is independently an alkyl group having 3 or less carbon atoms] and (e) the urea having two terminal alkoxysilane groups. In another embodiment, the copolymer includes the co-hydrolysis reaction product of (h) a urethane having two terminal alkoxysilane groups and (f) (RO)₄Si, wherein R is an alkyl group having 3 or less carbon atoms. In a related embodiment, the hydrolysis reaction product is further defined as the co-hydrolysis reaction product of (h), (f), and (g) (R¹O)₃SiR², wherein each of R¹ and R² is independently an alkyl group having 3 or less carbon atoms. It is also contemplated that the copolymer may include the condensation reaction product of [a hydrolysis reaction product of (RO)₄Si and (R¹O)₃SiR², wherein each of R, R¹ and R² is independently an alkyl group having 3 or less carbon atoms] and (h) a urethane having two terminal alkoxysilane groups. In these embodiments, (a)-(h) may be as described above or below. In addition, it is contemplated that the copolymer may be formed using a physical blend of a TQ resin with a polyorganosiloxane having a urea and/or urethane group and then partially condensing using acid and water.

As described above, the composition and copolymer are not particularly limited relative to a method of forming, synthesis, or preparation. Thus, the aforementioned reagents are not particularly limited and may be used in a molar excess, molar deficit, or in approximately equal molar amounts to form the copolymer.

### Isocyanates

In the aforementioned reaction schemes, and throughout this invention, one or more isocyanates may be utilized to form the urea and/or urethane groups of the prepolymer and/or copolymer. Examples of suitable, but non-limiting, isocyanates that may be used to form the prepolymers and/or copolymer of this invention include organic polyisocyanates, which may have two or more isocyanate functionalities, conventional aliphatic, cycloaliphatic, araliphatic and aromatic isocyanates, and combinations thereof. In various embodiments, the isocyanate is selected from the group of diphenylmethane diisocyanates (MDI), polymeric diphenylmethane diisocyanates (pMDI), toluene diisocyanates (TDI), hexamethylene diisocyanates (HDI), dicyclohexylmethane diisocyanates (HMDI), isophorone diisocyanates (IPDI), cyclohexyl diisocyanates (CHDI), and combinations thereof. In one embodiment, the isocyanate has the formula OCN—R—NCO, wherein R is selected from one of an alkyl group, an aryl group, and an arylalkyl group. In this embodiment, the isocyanate may include any number of carbon atoms, preferably from 4 to 20 carbon atoms.

Specific non-limiting examples of suitable isocyanates include alkylene diisocyanates having 4 to 12 carbons in an alkylene group such as 1,12-dodecane diisocyanate, 2-ethyl-1,4-tetramethylene diisocyanate, 2-methyl-1,5-pentamethylene diisocyanate, 1,4-tetramethylene diisocyanate and preferably 1,6-hexamethylene diisocyanate; cycloaliphatic diisocyanates such as 1,3- and 1,4-cyclohexane diisocyanate as well as any mixtures of these isomers, 1-isocyanato-3,3,5-trimethyl-5-isocyanatomethylcyclohexane, 2,4- and 2,6-hexahydrotoluene diisocyanate as well as the corresponding isomeric mixtures, 4,4′-2,2′-, and 2,4′-dicyclohexylmethane diisocyanate as well as the corresponding isomeric mixtures, and aromatic diisocyanates and polyisocyanates such as 2,4- and 2,6-toluene diisocyanate and the corresponding isomeric mixtures, 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates, as well as mixtures of MDI and toluene diisocyanates.

In one embodiment, the isocyanate is further defined as a diisocyanate. Diisocyanates include two isocyanate functional groups, i.e., two NCO groups. As described above, one or both of the two isocyanate functional groups may react with amine or alcohol groups to form the prepolymer. The other of the two isocyanate functional groups may remain unreacted.

Diisocyanates typically act as chain extenders, as shown, for example, above. It is to be appreciated that various amounts and combinations of one or more of the (di)isocyanates and one or more of the polyisocyanates may be utilized to introduce various combinations of chain extension and/or branching in the copolymer.

### Alkoxy Terminated Amines and Alcohols

In the aforementioned reaction schemes and throughout this invention, one or more amines and/or alcohols, e.g., one or more alkoxy terminated amines and/or alcohols, may be utilized to form the prepolymer and/or copolymer. Examples of suitable, but non-limiting, (alkoxy terminated) amines and alcohols include primary, secondary, and tertiary amines and alcohols that themselves have, or that may be bonded to one or more alkyl groups that have, from 1 to 12, 2 to 10, 3 to 9, 4 to 8, 5 to 7, 5 to 6, 1 to 4, 1 to 3, or 1 or 2, carbon atoms. It is contemplated that larger alkyl groups may also be utilized. It is also contemplated that linear, branched, and cyclic (alkoxy terminated) amines and alcohols may be used.

### Amine/Alcohol Terminated Polyorganosiloxanes

As first described above, one or more amine and/or alcohol terminated (e.g. mono-, di-, or poly-amine and/or -alcohol terminated) polyorganosiloxanes, e.g. T/Q polyorganosiloxanes, may be utilized in this invention. As a non-limiting example, one or more diamine terminated polyorganosiloxane, monoamine terminated polyorganosiloxane, dialcohol terminated polyorganosiloxane, monoalcohol terminated polyorganosiloxane, monoamine/monoalcohol terminated polyorganosiloxane, and/or combinations may be utilized. Tri-, tetra-, and other “poly-” amine and/or alcohol functional/terminated polyorganosiloxanes may also be utilized. Typically, these terminated polyorganosiloxanes have a weight average molecular weight of from 100 to 200,000, of from 1,000 to 50,000, or of from 1,000 to 10,000 g/mol.

In one embodiment, the terminated polyorganosiloxanes have the following formula:

(R¹R²₂SiO_{1/2})_{w}(R²₂SO_{2/2})ₓ(R²SiO_{3/2})_{y}(SiO_{4/2})_{z}

wherein each of R¹ and R² is independently an amine or alcohol group or a C₁-C₁₀ hydrocarbyl group such as an alkyl group, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl, a cycloalkyl group, such as cyclopentyl, cyclohexyl, and methylcyclohexyl, an aryl group, such as phenyl and naphthyl, or an alkaryl group, such as tolyl and xylyl, and aralkyl groups, such as benzyl and phenethyl. In addition, each of w, x, y, and z are mole fractions. More specifically, the each of w, x, y, and z typically has a value of from 0 to 0.9, from 0.25 to 0.75, from 0.25 to 0.5, or from 0.5 to 0.75. However, each of w, x, y, and z are not limited to these values and the values of each of w, x, y, and z may be any value or range of values within those described above.

In one embodiment, an amine terminated polyorganosiloxane, e.g. a T/Q polyorganosiloxane, is utilized to form segmented silicone-urea copolymers with alkoxysilane end groups. In another embodiment, an alcohol terminated polyorganosiloxane, e.g. a T/Q polyorganosiloxane, is utilized to form segmented silicone-urethane copolymers with alkoxysilane end groups. Typical, but non-limiting, terminal amine and alcohol groups are aminopropyl and hydroxypropyl groups, respectively. However, the polysiloxane may include a pendant functional group, such as an amine or alcohol pendant group, in addition to the terminal amine and/or alcohol groups. One suitable, but non-limiting, example of an amine terminated polyorganosiloxane is an aminopropyl terminated polydimethylsiloxane, commercially available as DMS-A11, DMS-A15 from Gelest, Inc. of Morrisville, Pa. Typically, the amine and/or alcohol terminated polyorganosiloxane(s) have a weight average molecular weight of from about 100 to about 200,000, more typically of from 1,000 to 50,000, and most typically of from 1,000 to 10,000, g/mol.

The copolymer may also be formed using any additives, stabilizers, etc. known in the art. In various embodiments, condensation, hydrolysis, and/or cross-linking catalysts are also utilized. Examples of suitable catalysts include, but are not limited to, such as metal salts and amines including sodium acetate, tetra-butyl titanate (TBT), tetra-isopropyl titanate (TPT), tin salt, zirconium salts, amines, and aminosilanes. In addition, the composition as a whole may include one or more additives such as adhesion promoters, corrosion inhibitors, diluents, anti-soiling additives, and combinations thereof, so long as the composition remains optically clear.

The composition and copolymer may be formed by any method in the art. Typically, the method of forming the composition and/or the copolymer includes the step of providing one or more reactants, e.g. one or more described above, and combining the reactants such that they react and form the copolymer. The method of forming the composition and/or the copolymer may include one or more additional steps of providing additives, catalysts, and the like and combining those additives/catalysts with reactants. The method of forming the composition and/or the copolymer may also include one or more heating, reflux, vacuum, distillation, separation, or other techniques.

### Film

In addition to the copolymer, this invention also provides a film. The film includes the composition and the condensation cured copolymer, i.e., the copolymer after it has cured via condensation. The film is not particularly limited in size, shape, or thickness and may be provided as individual sheets or in a roll. Alternatively, the film may be further defined as a coating or layer that is disposed on a substrate or article. The substrate or article is not particularly limited and may include glass, metal, polymers, plastics, wood, cement, aluminum, polyacrylate, polycarbonate, and the like. The film, after curing, typically has a pencil hardness of at least F, of from F to 7H, of from 3H to 7H, or of from 3H to 6H, measured according to ASTM D3363. In other embodiments, the film has a pencil hardness of from 5H to HB, measured according to ASTM D3363. The film may be formed by any method known in the art. Typically, the composition is disposed on the substrate, as described above, at a wet build thickness of from 1 to 10, of from 1 to 6, of from 1 to 3, or of from 3 to 6, mils, and cured to form the film, which may have the same or a different thickness after curing. The composition is typically disposed on the substrate via manual and/or automatic spraying, pouring, placing, dipping, rolling, brushing, and combinations thereof.

After being disposed on the substrate, the composition is then typically condensation cured. Any condensation curing techniques or environments may be utilized. In one embodiment, the composition is heat cured for a time of from 30 minutes to 2 hours, from 10 minutes to 1.5 hours, or from 5 minutes to 30 minutes at a temperature of from 50 to 150° C., of from 90 to 120° C., or from 80 to 100° C. Alternatively, the composition may be cured at room temperature or at less than room temperature.

### Coating System

This invention further provides a coating system that includes a clear coat layer. The clear coat layer includes the optically clear condensation cured composition wherein this composition, prior to condensation curing, includes the silicone-organic copolymer described above. Typically, the clear coat layer has a thickness of from 0.5 to 5, from 0.5 to 4, from 0.5 to 3, from 0.5 to 2, or from 0.5 to 1, mil thickness, but is not limited to such dimensions.

The coating system includes a sub-clear coat layer or and may include more than one sub-clear coat layer disposed in contact with the clear coat layer. The sub-clear coat layer may be further defined as a base coat layer, a primer layer, and/or any other sub-clear coat layer that is known in the art. In one embodiment, the coating system includes only the clear coat layer (e.g. a film) and, optionally, the sub-clear coat layer(s). The coating system may be disposed on any substrate, such as the substrates described above. For example, if the coating system is used on a vehicle body, the coating system typically includes multiple sub-clear coat layers, e.g. a basecoat layer, a primer layer, and an e-coat layer.

The coating system may be formed by any method known in the art including the steps and techniques described above relative to the method of forming the film. In addition, any chemistry known in the art to be suitable for forming base coat layers, primer layers, or other sub-clear coat layers may be used. The clear coat layer and the sub-clear coat layer(s) may be formed wet-on-wet on a substrate, such as a vehicle body. For example, the primer layer may be formed on the substrate, the base coat layer may be formed on the primer layer and the clear coat layer is typically formed on the base coat layer while both the primer layer and the base coat layer are still wet. Once each of the layers is in place, the layers are then cured through methods that are known in the art.

### EXAMPLES

A series of compositions (Inventive Compositions 1-3) that include the inventive copolymer are formed according to this invention. Samples of Inventive Compositions 1-3 are applied to aluminum and polycarbonate substrates and condensation cured to form a series of films (Inventive Films 1A/B-3A/B, respectively) also of this invention.

A series of comparative compositions (Comparative Compositions 1-4) are also formed but do not represent this invention because they do not include a condensation curable silicone-organic copolymer that has at least one alkoxysilane group, at least one T unit, and at least one Q unit, wherein a silicon atom of at least one of the T and Q units is bonded to a urea group and/or a urethane group. Samples of Comparative Compositions 1-4 are also applied to aluminum and polycarbonate substrates and cured to form a series of comparative films (Comparative Films 1A/B-4A/B, respectively). After formation and curing, the Films and the Comparative Films are evaluated to determine structural integrity (cracking) and pencil hardness, as described in detail below.

### Comparative Composition 1: Unmodified T/Q Resin—No Bonds to a Urea/Urethane Group

To form Comparative Composition 1, about 10 g of colloidal silica are combined with about 27 g of MTM, about 5 g of acetic acid, and about 4 g of water in a round bottomed flask equipped with magnetic stir bar, thermometer, and condenser. This combination of components is refluxed for about 1 h at 67° C. and about 11.7 g of MeOH are removed using the Dean-Stark distillation procedure. After removing MeOH, about 60 g of 1-Butanol, about 11 g of PM acetate, and about 0.002 g of TBT catalyst are added to the flask and mixed at room temperature to form a T/Q resin. This T/Q resin does not include any bonds to a urea or urethane group.

A 10 g sample of Comparative Composition 1 is coated on an aluminum panel at a wet thickness of about 3 mils. A second 10 g sample of Comparative Composition 1 is coated on a polycarbonate panel at a wet thickness of about 3 mils. These two samples are heat cured for 2 hours at 80° C. to provide brittle films (Comparative Films 1A and 1B).

### Comparative Composition 2: Alkoxy Terminated Urea Prepolymer—No Q Units

To form Comparative Composition 2, about 2.8 g of aminopropyltriethoxysilane solution is combined at room temperature with about 20 g of Isopropanol (IPA) in a round bottomed flask equipped with a magnetic stir bar, thermometer and condenser. Subsequently, about 3 g of isophorone diisocyanate (IPDI) is added to the flask dropwise. This combination is mixed for 2 hours at room temperature. About 0.002 g of TBT catalyst is added and Comparative Composition 2 is formed that includes the following alkoxy terminated urea pre-polymer:

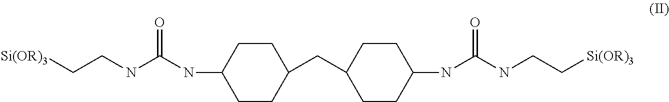

This prepolymer of Comparative Composition 2 does not include any Q units and thus is not representative of this invention.

A 10 g sample of Comparative Composition 2 is coated on an aluminum panel at a thickness of about 3 mils. A second 10 g sample of Comparative Composition 2 is coated on a polycarbonate panel at a thickness of about 3 mils. These two samples are heat cured for 2 hours at 80° C. to provide films (Comparative Films 2A and 2B, respectively).

### Comparative Composition 3: Alkoxy Functional Urea Prepolymer—No Q Units

To form Comparative Composition 3, about 5 g of the prepolymer of Comparative Composition 2 described immediately above is combined with about 5 g of the following prepolymer in the presence of about 0.005 g of TBT wherein n=10:

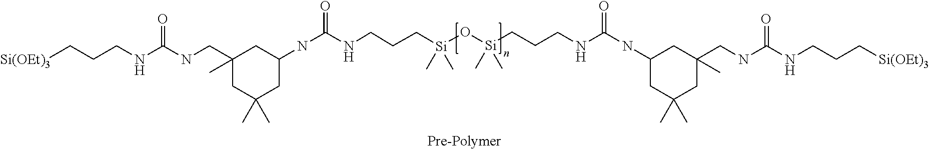

The product formed from herein does not include any Q units and thus is not representative of this invention.

Subsequently, a 10 g sample of Comparative Composition 3 is coated on an aluminum panel at a thickness of about 3 mils. A second 10 g sample of Comparative Composition 3 is coated on a polycarbonate panel at a thickness of about 3 mils. These two samples are heat cured for 2 hours at 80° C. to provide films (Comparative Films 3A and 3B, respectively).

### Comparative Composition 4: Alkoxy Functional Urea Prepolymer—No Q Units

To form Comparative Composition 4, about 5 g of each of the following prepolymers is combined in the presence of about 0.005 g of TBT catalyst. More specifically, 5 grams of the following prepolymer is utilized wherein n=10.

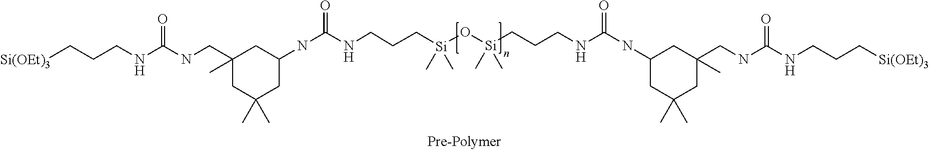

An additional 5 grams of the following prepolymer is also utilized wherein n=1.

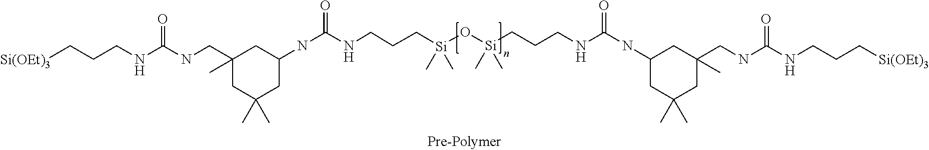

The product formed from the combination of the aforementioned prepolymers does not include any Q units and thus is not representative of this invention.

Subsequently, a 10 g sample of Comparative Composition 4 is coated on an aluminum panel at a thickness of about 3 mils. A second 10 g sample of Comparative Composition 4 is coated on a polycarbonate panel at a thickness of about 3 mils. These two samples are heat cured for 2 hours at 80° C. to provide films (Comparative Films 4A and 4B, respectively).

### Inventive Composition 1: Condensation Curable Silicone-Organic Copolymer

To form Inventive Composition 1, about 5 grams of the following prepolymer, wherein n=10, are combined with about 5 grams of the TQ resin of Comparative Composition 1 in the presence of about 0.005 grams of TBT catalyst:

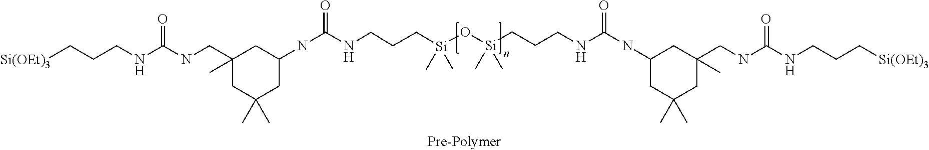

The product, i.e., a condensation curable silicone-organic copolymer, formed herein has at least one alkoxysilane group, at least one T unit, and at least one Q unit, and is representative of one embodiment of the copolymer of this invention. In addition, this copolymer also includes at least one D unit.

Subsequently, a 10 g sample of Inventive Composition 1 is coated on an aluminum panel at a thickness of about 3 mils. A second 10 g sample of Inventive Composition 1 is coated on a polycarbonate panel at a thickness of about 3 mils. These two samples are heat cured for 2 hours at 80° C. to provide films (Inventive Films 1A and 1B, respectively).

### Inventive Composition 2: Condensation Curable Silicone-Organic Copolymer

To form Inventive Composition 2, about 5 grams of the following prepolymer, wherein n=10, are combined with about 5 grams of a TQ resin (formed using the method described below) in the presence of about 0.005 grams of TBT catalyst:

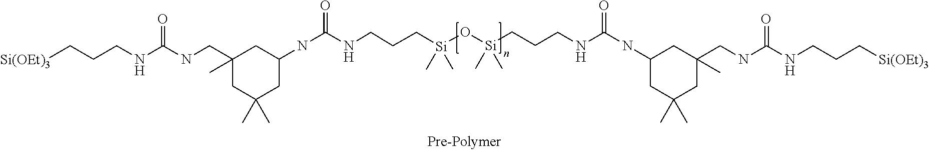

The product, i.e., a condensation curable silicone-organic copolymer, formed herein has at least one alkoxysilane group, at least one T unit, and at least one Q unit, and is representative of one embodiment of the copolymer of this invention. In addition, this copolymer also includes at least one D unit.

The TQ resin used to form Inventive Composition 2 is itself formed from the partial co-hydrolysis of methyltrimethoxysilane (MTM) and tetraethoxysilane (TEOS). More specifically, about 108 g of MTM are combined with about 40 g of TEOS, about 19 g of acetic acid, and about 18 g of water in a round bottomed flask equipped with magnetic stir bar, thermometer, and condenser. This combination of components is refluxed for about 1 h at 67° C. and MeOH is removed using the Dean-Stark distillation procedure to form the T/Q resin utilized in this example. This T/Q resin does not include any bonds to a urea or urethane group prior to reaction with the aforementioned prepolymer during the formation of Comparative Composition 2.

A 10 g sample of Inventive Composition 2 is coated on an aluminum panel at a thickness of about 3 mils. A second 10 g sample of Inventive Composition 2 is coated on a polycarbonate panel at a thickness of about 3 mils. These two samples are heat cured for 2 hours at 80° C. to provide hard films (Inventive Films 2A and 2B, respectively).

### Inventive Composition 3: Condensation Curable Silicone-Organic Copolymer

To form Inventive Composition 3, about 5 grams of the following prepolymer are combined with about 5 grams of the immediately aforementioned TQ resin in the presence of about 0.005 grams of TBT catalyst:

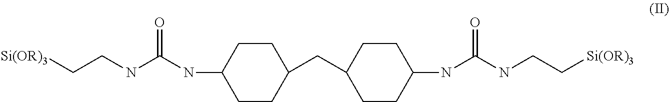

The product, i.e., a condensation curable silicone-organic copolymer, formed herein has at least one alkoxysilane group, at least one T unit, and at least one Q unit, and is representative of one embodiment of the copolymer of this invention.

Subsequently, a 10 g sample of Inventive Composition 3 is coated on an aluminum panel at a thickness of about 3 mils. A second 10 g sample of Inventive Composition 3 is coated on a polycarbonate panel at a thickness of about 3 mils. These two samples are heat cured for 2 hours at 80° C. to provide hard films (Inventive Films 3A and 3B, respectively).

### Evaluation of the Films

After formation, samples of Films 1A/B-3A/B and Comparative Films 1A/B-4A/B are placed in a QUV chamber for varying times up to 370 hours pursuant to ASTM D4329. Various samples of the films are evaluated after 24 hrs, 124 hrs, and 370 hrs to determine pencil hardness according to ASTM D3363. After 370 hrs, the samples are also visually evaluated to determine the structural integrity of the films (cracked/not cracked). The results are set forth below:

| | | Structural | Pencil | Pencil | Pencil |
|---|---|---|---|---|---|
| | | Integrity | Hardness | Hardness | Hardness |
| Film | Substrate | 370 hrs | 24 hrs | 124 hrs | 370 hrs |
| Comp. Film 1A | Aluminum | Cracked | 4 | 8 | 16 |
| Comp. Film 1B | Polycarbonate | Cracked | 3 | 9 | Not Tested |
| Comp. Film 2A | Aluminum | Not Cracked | 5 | 7 | 7 |
| Comp. Film 2B | Polycarbonate | Not Cracked | 4 | 8 | Not Tested |
| Comp. Film 3A | Aluminum | Not Cracked | 5 | 8 | 10 |
| Comp. Film 3B | Polycarbonate | Not Cracked | 7 | 8 | Not Tested |
| Comp. Film 4A | Aluminum | Not Cracked | 3 | 8 | 9 |
| Comp. Film 4B | Polycarbonate | Not Cracked | 4 | 6 | Not Tested |
| Invent. Film 1A | Aluminum | Not Cracked | 6 | 5 | 6 |
| Invent. Film 1B | Polycarbonate | Not Cracked | 4 | 5 | Not Tested |
| Invent Film 2A | Aluminum | Not Cracked | 4 | 4 | 4 |
| Invent. Film 2B | Polycarbonate | Not Cracked | 5 | 8 | Not Tested |
| Invent. Film 3A | Aluminum | Not Cracked | 4 | 5 | 7 |
| Invent. Film 3B | Polycarbonate | Not Cracked | 5 | 9 | Not Tested |

The Pencil Hardness data set forth above generally corresponds to the following:

| Qualitative | Pencil Hardness | Numerical Scale Used in |
|---|---|---|
| Scale | Scale | The Instant Examples |
| Softest | 7B | 16 |
| | 6B | 15 |
| | 5B | 14 |
| | 4B | 13 |
| | 3B | 12 |
| | 2B | 11 |
| | B | 10 |
| | HB | 9 |
| | F | 8 |
| | H | 7 |
| | 2H | 6 |
| | 3H | 5 |
| | 4H | 4 |
| | 5H | 3 |
| | 6H | 2 |
| Hardest | 7H | 1 |

The data set forth in the Tables above clearly shows that the various Films 1A/B-3A/B of this invention generally out-perform the Comparative Films 1A/B-4A/B because the Films of this invention generally have a high pencil hardness (i.e., low numerical number) both initially and, perhaps more importantly, over time and after ageing. Said differently, the Films of this invention maintain excellent hardness values after ageing which is surprising, and superior, and compared to the Comparative Films. The pencil hardness of the Comparative Films increases over time much more than the pencil hardness of the Films of this invention. In addition, the Films of this invention are resistant to cracking. The presence of the silicone-urea/urethane prepolymer tends to impart improved flexibility and toughness to the Films of this invention. Presence of a D unit tends to improve flexibility of the compositions while the urea/urethane improves both toughness and scratch resistance of the Films of this invention.

It is to be understood that any of the numerical values associated with this invention, e.g. molecular weight ranges, ratios, etc., are not particularly limiting and may vary. For example, any of the aforementioned numerical values may be further defined as any value or range of values, both whole and fractional, within those ranges and values described above and/or may vary from the values and/or range of values described above by ±5%, ±10%, ±15%, ±20%, ±25%, ±30%, etc. so long as the variance remains within the scope of the invention.

It is also to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is further to be understood that any ranges and sub-ranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and sub-ranges sufficiently describe and enable various embodiments of the present invention, and such ranges and sub-ranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes sub-ranges and/or an upper or lower limit. As another example, a range of “at least 10” inherently includes a sub-range of from at least 10 to 35, a sub-range of from at least 10 to 25, a sub-range of from 25 to 35, and so on, and each sub-range may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

Preferably, said urea group and/or said urethane group is bonded to a silicon atom of at least one Q unit.

Preferably, said urea group and/or said urethane group is bonded to a silicon atom of at least one T unit.

Preferably, each alkoxysilane group has 3 or less carbon atoms. More preferably, each alkoxysilane group is further defined as a methoxysilane group.

The invention extends to a film comprising an optically clear condensation cured composition wherein said composition, prior to condensation curing, comprises a silicone-organic copolymer that has at least one alkoxysilane group, at least one T unit, and at least one Q unit, wherein a silicon atom of at least one of said T and Q units is bonded to a urea group and/or a urethane group. Preferably said urea group and/or said urethane group is bonded to a silicon atom of at least one Q unit. Preferably, a urea group and/or a urethane group is bonded to a silicon atom of at least one T unit.

The invention extends to a film wherein each alkoxysilane group has 3 or less carbon atoms. Preferably each alkoxysilane group is further defined as a methoxysilane group.

The invention extends a method of forming such film.

1. An optically clear composition comprising a condensation curable silicone-organic copolymer that has at least one alkoxysilane group, at least one T unit, and at least one Q unit, wherein a silicon atom of at least one of said T and Q units is bonded to a urea group and/or a urethane group.

2. An optically clear composition as set forth in claim 1 wherein said copolymer further has at least one D unit and a urea group and/or a urethane group is bonded to a silicon atom of said at least one D unit.

3. An optically clear composition as set forth in claim 1 wherein said T and Q units are present in a ratio of from 1:1 to 10:1.

4. An optically clear composition as set forth in claim 1 wherein said condensation curable silicone-organic copolymer has a weight average molecular weight of from 1,000 to 50,000 g/mol.

5. An optically clear composition as set forth in claim 1 wherein said condensation curable silicone-organic copolymer comprises the reaction product of (a) a urea having a terminal alkoxysilane group and a terminal isocyanate group and (b) an amine terminated polyorganosiloxane and optionally (c) an alcohol terminated polyorganosiloxane.

6. An optically clear composition as set forth in claim 1 wherein said condensation curable silicone-organic copolymer comprises the reaction product of (d) a urethane having a terminal alkoxysilane group and a terminal isocyanate group and either (b) an amine terminated polyorganosiloxane or (c) an alcohol terminated polyorganosiloxane.

7. An optically clear composition as set forth in claim 6 wherein said (d) urethane is further defined as having two urethane groups and/or said (b) polyorganosiloxane is further defined as having two terminal amine groups and/or said (c) polyorganosiloxane is further defined as having two terminal alcohol groups.

8. An optically clear composition as set forth in claim 1 wherein said condensation curable silicone-organic copolymer comprises the co-hydrolysis reaction product of (e) a urea having two terminal alkoxysilane groups and (f) (RO)₄Si, wherein R is an alkyl group having 3 or less carbon atoms and optionally (g) (R¹O)₃SiR², wherein each of R¹ and R² is independently an alkyl group having 3 or less carbon atoms.

9. An optically clear composition as set forth in claim 1 wherein said condensation curable silicone-organic copolymer comprises the condensation reaction product of a hydrolysis reaction product of (RO)₄Si and (R¹O)₃SiR², wherein each of R, R¹ and R² is independently an alkyl group having 3 or less carbon atoms and (e) a urea having two terminal alkoxysilane groups.

10. An optically clear composition as set forth in claim 1 wherein said condensation curable silicone-organic copolymer comprises the co-hydrolysis reaction product of (h) a urethane having two terminal alkoxysilane groups and (f) (RO)₄Si, wherein R is an alkyl group having 3 or less carbon atoms and optionally (g) (R¹O)₃SiR², wherein each of R¹ and R is R² is independently an alkyl group having 3 or less carbon atoms.

11. An optically clear composition as set forth in claim 1 wherein said condensation curable silicone-organic copolymer comprises the condensation reaction product of a hydrolysis reaction product of (RO)₄Si and (R¹O)₃SiR², wherein each of R, R¹ and R² is independently an alkyl group having 3 or less carbon atoms and (h) a urethane having two terminal alkoxysilane groups.

12. A film comprising an optically clear condensation cured composition wherein said composition, prior to condensation curing, comprises a silicone-organic copolymer that has at least one alkoxysilane group, at least one T unit, and at least one Q unit, wherein a silicon atom of at least one of said T and Q units is bonded to a urea group and/or a urethane group.

13. A film as set forth in claim 12 wherein said copolymer further has at least one D unit and a urethane group is bonded to a silicon atom of said at least one D unit.

14. A coating system comprising:
a clear coat layer comprising an optically clear condensation cured composition wherein said composition, prior to condensation curing, comprises a silicone-organic copolymer that has at least one alkoxysilane group, at least one T unit, and at least one Q unit, wherein a silicon atom of at least one of said T and Q units is bonded to a urea group and/or a urethane group; and
at least one sub-clear coat layer disposed in contact with said clear coat layer.

15. A coating system as set forth in claim 14 wherein said copolymer further has at least one D unit and a urea group and/or a urethane group is bonded to a silicon atom of said at least one D unit.
